(19) United States
(12) Patent Application Publication
(10) Pub. No.: US 2004/0076499 A1
(43) Pub. Date: Apr. 22, 2004

(54) Pallet fork assembly

(76) Inventor: Ivan Kirilov Gramatikov, Hamilton (CA)

Correspondence Address: QUARLES & BRADY LLP, 411 E. WISCONSIN AVENUE, SUITE 2040, MILWAUKEE, WI, 53202-4497, US

(21) Appl. No.: 10/274,903

(22) Filed: Oct. 18, 2002

(51) Int. Cl. B60P 1/02

(52) U.S. Cl. 414/495

(57) ABSTRACT

A pallet truck including a fork assembly. The truck includes a truck body and a control handle extending from the truck body. The fork assembly includes at least one elongated fork fixed to the truck body for vertical movement. The fork includes a top wall extending between fork ends and a pair of side walls extending from opposing edges of the top wall to form a downwardly opening cavity extending at least partially between the fork ends. A pair of opposing intermediate blocks are rigidly fixed to the fork and define a space therebetween. Each block is adjacent one of the fork sides and has a pivot shaft bore formed therein. The pivot shaft bores are coaxial. A shaft extends through the space between the intermediate blocks, into the pivot shaft bores, and short of the fork sides. The shaft has a shaft axis. A pivot arm has one end fixed to the shaft, and is pivotable about the shaft axis. A support wheel is rotatably fixed to an opposing end of the pivot arm.

### CROSS REFERENCES TO RELATED APPLICATIONS

Not Applicable

### STATEMENT REGARDING FEDERALLY SPONSORED RESEARCH

Not Applicable.

### BACKGROUND OF THE INVENTION

The present invention relates to pallet trucks, and more particularly to a pallet truck having a fork trail assembly for supporting a distal end of a fork.

Pallet trucks typically includes a wheel mounted frame upon which a pair of load supporting forks is mounted for vertical movement. Each fork is typically an elongated U-shaped structure having a proximal end and a distal end. The proximal end is fixed to the truck for vertical movement between a raised and lowered position. The U-shaped structure includes a pair of reinforced opposing walls which define a space in which a fork trail assembly is housed. The fork trail assembly is fixed to each fork proximal the fork distal end, and extends and retracts to support the fork distal end.

Each fork trail assembly typically includes a pivot shaft penetrating the opposing walls of the fork. A pivot arm which is part of the fork trail assembly is pivotally fixed to the pivot shaft, and a ground engaging wheel is rotatably mounted to the pivot arm. The pivot arm is pivoted to maintain contact of the ground engaging wheel with a support surface as the fork is raised and lowered to support the distal end of the fork.

Penetrations in the opposing fork walls to mount the pivot shaft weakens the structural integrity of the fork, as compared to a fork without penetrations, by reducing the section modulus of the fork at the point of the highest bending moment when the fork is subjected to tip loading. Tip loading is defined as exerting a force proximal the tip of the fork, such as by lifting a load only by engaging the tip of the fork with the load. The weakened structural integrity of the fork caused by the removed material for the pivot shaft can result in the fork buckling under certain tip loading conditions.

The structural integrity of the fork frame can also be furthered diminished by clearance cutouts formed in the top of the fork for accommodation of the fork trail assembly. The weakened structural integrity of the fork reduces the load capacity of the entire pallet truck. Therefore, a need exists for an improved fork assembly which does not have a reduced section modulus at the point of the highest bending moment when the fork is subjected to tip loading.

### SUMMARY OF THE INVENTION

The present invention provides a pallet truck including a fork assembly. The truck includes a truck body and a control handle extending from the truck body. The fork assembly includes at least one elongated fork fixed to the truck body for vertical movement. The fork includes a top wall extending between fork ends and a pair of side walls extending from opposing edges of the top wall to form a downwardly opening cavity extending at least partially between the fork ends. A pair of opposing intermediate blocks are rigidly fixed to the fork and define a space therebetween. Each block is adjacent one of the fork sides and has a pivot shaft bore formed therein. The pivot shaft bores are coaxial. A shaft extends through the space between the intermediate blocks, into the pivot shaft bores, and short of the fork sides. The shaft has a shaft axis. A pivot arm has one end fixed to the shaft, and is pivotable about the shaft axis. A support wheel is rotatably fixed to an opposing end of the pivot arm.

A general objective of the present invention is to provide a pallet truck with a fork having an improved structural integrity. This objective is accomplished by providing an intermediate block which is fixed to the fork and pivotally supports the pivot arm.

Another objective of the present invention is to increase the section modulus of the fork in critical areas during tip loading. This objective is accomplished by fixing the intermediate block to the fork through a hole formed in the fork side wall which is rearward of the pivot shaft axis of the fork trail assembly.

These and still other objectives and advantages of the present invention will be apparent from the description which follows. In the detailed description below, preferred embodiments of the invention will be described in reference to the accompanying drawings. These embodiments do not represent the full scope of the invention. Rather the invention may be employed in other embodiments. Reference should therefore be made to the claims herein for interpreting the breadth of the invention.

### BRIEF DESCRIPTION OF THE DRAWINGS

FIG. 1 is a perspective view of a pallet truck incorporating the present invention;

FIG. 2 is a bottom perspective view of the pallet truck of FIG. 1;

FIG. 3 is a perspective view of the fork trail assembly of FIG. 1;

FIG. 4 is a side view of one of the forks of FIG. 1;

FIG. 5 is an enlarged perspective view of the fork trail assembly of FIG. 1;

FIG. 6 is a bottom view of the fork trail assembly of FIG. 1; and

FIG. 7 is an another embodiment of an interface between the shaft and intermediate block for use in the present invention.

### DETAILED DESCRIPTION OF PREFERRED EMBODIMENTS

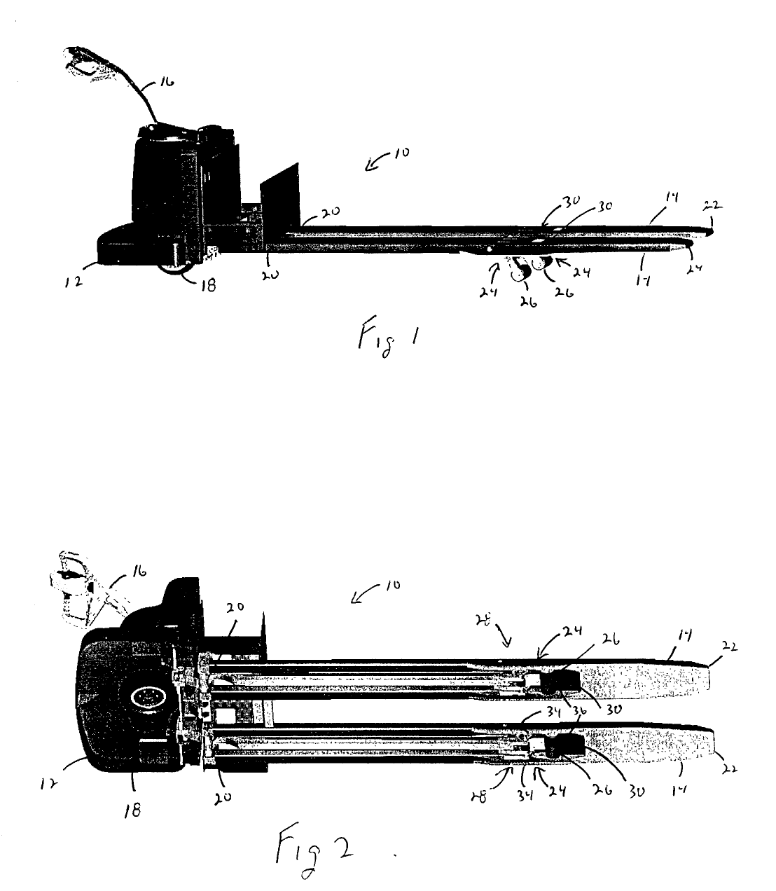

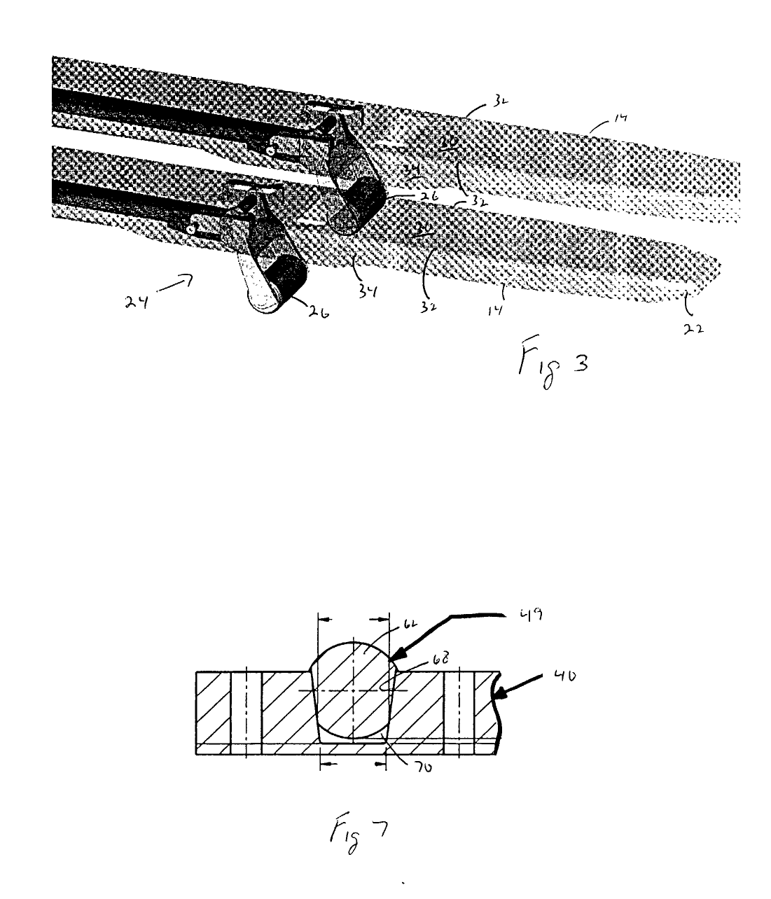

A powered pallet truck 10 shown in FIGS. 1-3 includes a wheel mounted chassis 12, or body, upon which a pair of load supporting forks 14 is mounted for vertical movement. A control handle 16 extending from the chassis 12 controls the speed and direction of the truck 10. The chassis 12 houses a power unit (not shown), such as a hydraulic power unit, which powers a lifting mechanism (not shown) to raise and lower the forks 14 and a traction motor (not shown) which rotatably drives a drive wheel 18 in response to inputs provided by an operator through the control handle 16. Although a powered pallet truck is disclosed, the pallet truck can be a manual truck without departing from the scope of the invention.

Each load supporting fork 14 extends forwardly from the chassis 12, and has a proximal end 20 fixed to the chassis 12 for vertical movement and a distal end 22. The distal end 22 is supported by a fork trail assembly 24 having a ground engaging wheel 26 which extends from the fork 14 as the fork 14 is raised vertically. Each fork 14 also includes a U-shaped section 28 having a top wall 30 which engages a load supported by the fork 14. The top wall 30 includes opposing longitudinal edges 32. A downwardly depending side wall 34 joined to each top wall edge 32 in an edge to edge relation defines the U-shape and a retraction space 36 between the side walls 34 for the fork trail assembly 24.

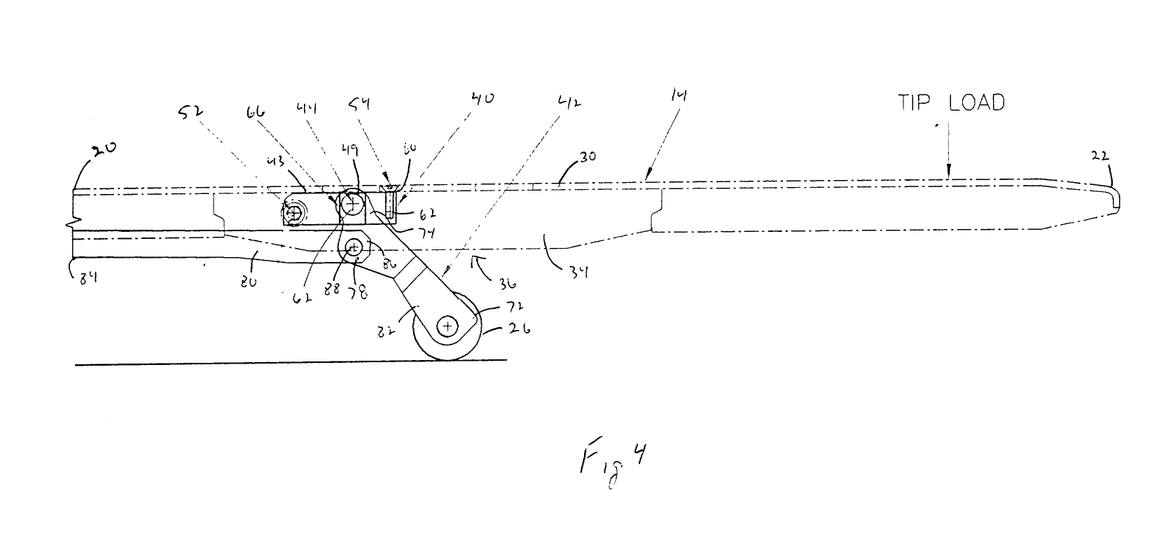

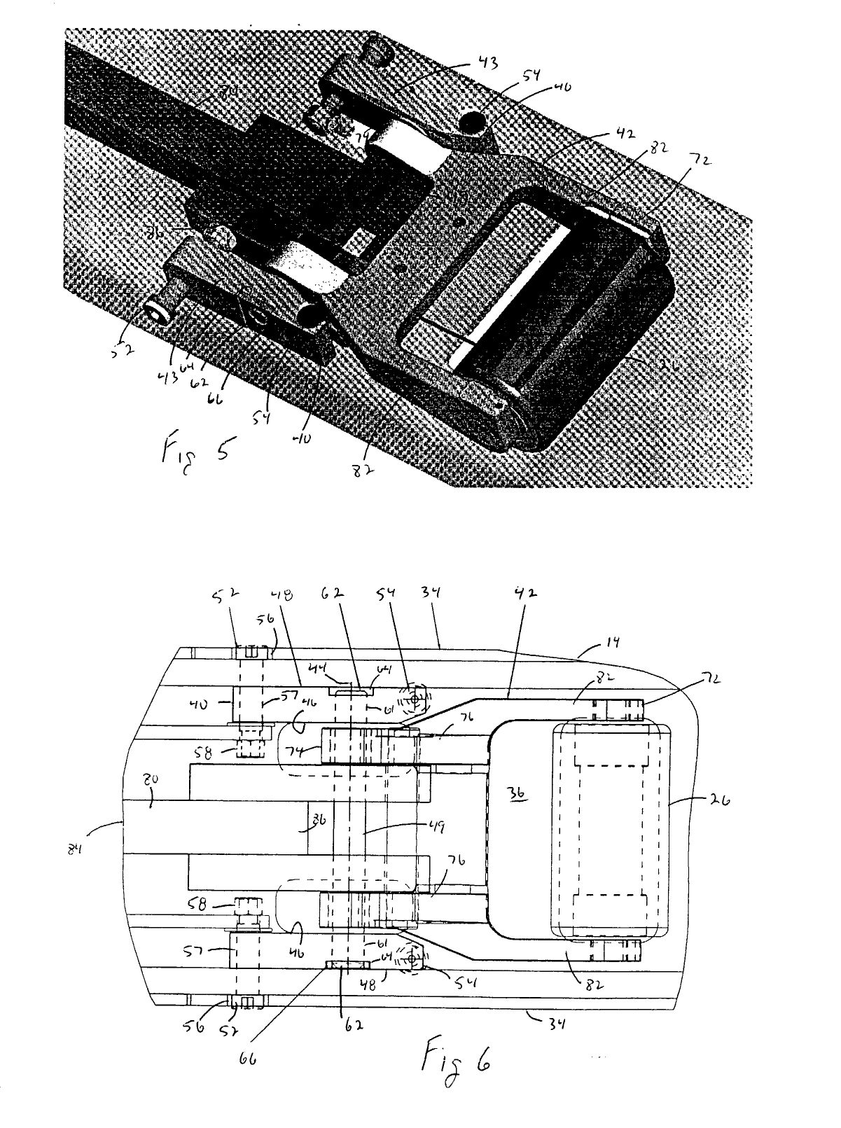

As shown in FIGS. 4-6, the fork trail assembly 24 supports the distal end 22 of the fork 14, and includes a pair of opposing intermediate blocks 40 rigidly fixed to the fork 14. The blocks 40 pivotally mount a pivot arm 42, also known as a fork trail, which pivots about a pivot shaft axis 44 of a pivot shaft 49 to extend and retract the ground engaging wheel 26. The wheel 26 can be any wheel used in the art, such as a bearing mounted wheel formed from steel, nylon, polyurethane, and the like. Although only one wheel is shown, the fork trial assembly can include one or more wheels without departing from the scope of the invention.

Each intermediate block 40 is substantially rectangular having a narrow top 43 adjacent the fork top wall 30, an interior side 46 facing the other intermediate block 40, and an opposing exterior side 48 facing the adjacent fork side wall 34. Each block 40 is rigidly fixed to the fork 14 inside the fork retraction space 36, and the block interior sides 46 define a space for retracting the pivot arm 42 therebetween. Advantageously, the intermediate blocks 40 reinforces the fork 14 proximal the pivot axis 44. Although a rectangular intermediate block 40 is preferred, the block can have any shape without departing from the scope of the invention.

Preferably, the intermediate block top 43 is in contact with the fork top wall 30, such that vertical loads can be transferred through the contact surface between the intermediate block top 43 and fork top wall 30. Although providing an interface for transferring vertical loads between the intermediate block top and fork top wall is preferred, vertical loads can be transferred through fasteners, an intermediate material between the intermediate block top and fork trop wall, and the like, without departing from the scope of the invention.

The intermediate blocks 40 are, preferably, formed from a rigid material, such as an iron alloy, and are fixed to the fork using methods known in the art, such as bolting, welding, and the like. Preferably, each block 40 is fixed to the fork by a pair of bolts 52, 54 to simplify installation and maintenance. One bolt 52 extends through a counterbore hole 56 formed in the fork side wall 34 and a bore 57 formed through the block 40. The bolt 52 threadably engages a nut 58 adjacent the intermediate block interior side 46 to fix the block 40 to the fork 14. The counterbore hole 56 is formed rearwardly (i.e. between the pivot shaft axis 44 and the fork proximal end 20) of the pivot shaft axis 44 to provide a section modulus of the fork in a vertical plane containing the pivot shaft axis 44 when the fork 14 is subject to tip loading which is greater than the section modulus of the fork in the same plane when a hole is coaxial with the pivot shaft axis 44. Although a bolt/nut combination is preferred, the bolt can threadably engage a threaded bore formed in the block to eliminate the nut without departing from the scope of the invention.

The second bolt 54 extends through a countersunk hole 60 formed in the fork top wall 30, and threadably engages a threaded bore 62 formed through the intermediate block top 43. The countersunk hole 60 formed in the top wall 30 is, preferably, formed forwardly of the pivot shaft axis 44 to securely fix the intermediate block 40 to the fork 14. The hole 60 formed in the top wall 30 can be formed in the same vertical plane containing the pivot shaft axis 44 or rearwardly of the pivot shaft axis 44 without departing from the scope of the present invention. Of course, the second bolt 54 can fix the block 40 to the fork 14 using a nut, as in the first bolt 52.

Each intermediate block 40 includes a pivot shaft bore 61 formed through the block sides 46, 48. The pivot shaft bores 60 are coaxial, and each bore 61 receives one end 62 of the pivot shaft 49. Preferably, a slot 64 is formed in the intermediate block exterior side 48. The slot 64 intersects with the pivot shaft bore 61 for securing the pivot shaft 49 against rotation. Although a slot 64 formed in both intermediate block exterior sides 48 is shown, in this embodiment only one slot 64 need be provided to secure the pivot shaft 49 against rotation.

The pivot shaft 49 extends through the space between the intermediate blocks 40, and each shaft end 62 extends into one of the pivot shaft bores 60. Preferably, each pivot shaft end 62 extends through the respective pivot shaft bore 61 and into the respective slot 64 formed in the intermediate block side 48 intersecting the pivot shaft bore 61. Importantly, the pivot shaft bore ends 62 do not extend through the fork side walls 34 to reduce the section modulus of the fork 14 when the fork 14 is tip loaded.

As shown in FIGS. 3-6, the pivot shaft 49 is secured from rotating in the pivot shaft bores 60 by a rectangular plate 66 fixed to one end 62 of the shaft 49 using methods known in the art, such as welding. The rectangular plate 66 is captured in the slot 64 formed in the intermediate block exterior side 48 to prevent the shaft 49 from rotating. The fork side wall 34 adjacent the block exterior side 48 prevents the shaft 49 from moving axially out of the slot 64, and the fork top wall 30 prevents the plate 66 from moving radially out of the slot 64. Although securing the pivot shaft 49 from rotating is preferred, the shaft 49 can be allowed to rotate, or can be secured using other methods known in the art, such as by welding the shaft to at least one of the intermediate blocks, forming at least one intermediate block from at least two pieces and clamping at least one shaft end between the pieces, forming flats 68 on at least one shaft end 62 which are received in a tapered slot 70 formed in the exterior side 48 of the intermediate block 40, such as shown in FIG. 7, and the like, without departing from the scope of the invention.

The pivot arm 42 is pivotally fixed to the pivot shaft 49, and pivots to extend and retract the wheel 26 as the fork 14 is raised and lowered. The pivot arm 42 includes a distal end 72 and a proximal end 74. The pivot arm proximal end 74 includes a pair of legs 76 pivotally fixed to the pivot shaft 49. Each leg 76 includes a lug 78 (best shown in FIG. 4) for attaching a pull rod 80 thereto. The pull rod 80 exerts a force on the pivot arm 42 as the fork 14 is raised and lowered.

The pivot arm distal end 72 includes a pair of opposing legs 82 which rotatably mount the wheel 26 therebetween. Although a pair of legs 82 is preferred, the distal end 72 can be any shape suitable for rotatably mounting one or more wheels thereto, such as a single leg having a wheel shaft fixed thereto, and the like without departing from the scope of the invention.

As best shown in FIG. 4, the pull rod 80 has a proximal end 84 linked with the chassis 12, as is known in the art, such that the pull rod 80 exerts a force to pivot the pivot arm 42 about the shaft axis 44 to extend the wheel 26 as the fork 14 is raised and to retract the wheel 26 as the fork 14 is lowered. The distal end 86 of the pull rod 80 is interposed between the pivot arm lugs 78. A pin 88 extending between the lugs 78 and through the pull rod 80 pivotally connects the pull rod 80 to the pivot arm 42.

In use, the fork trail assembly 24 supports the fork distal end 22. Vertical loads on the fork 14 are transferred to the intermediate blocks 40 through the fork top wall 30, and horizontal loads on the fork 14 are transferred between the intermediate block 40 and the fork 14 through the bolts 52, 54 securing the block 40 to the fork 14. When the fork 14 is raised, the pull rod 80 exerts a force on the pivot arm 42 to extend the fork trail assembly 24 and maintain the wheel 26 engaged with the ground. When the fork 14 is lowered, the pull rod 80 exerts a force on the pivot arm 42 to retract the fork trail assembly 24 into the space 36 between the fork side walls 34 while maintaining the wheel 26 engaged with the ground.

While there has been shown and described what are at present considered the preferred embodiments of the invention, it will be obvious to those skilled in the art that various changes and modifications can be made therein without departing from the scope of the invention defined by the appended claims.

I claim:

1. A fork assembly suitable for use on a pallet truck, said fork assembly comprising:
an elongated fork having a proximal end and a distal end, said proximal end being fixable to a pallet truck body, said fork extending forwardly from said proximal end toward said distal end, and including a top wall extending between said fork ends and a pair of side walls extending from opposing edges of said top wall to form a downwardly opening cavity extending at least partially between said fork ends;
a pair of opposing intermediate blocks rigidly fixed to said fork proximal said fork distal end and defining a space therebetween, each block being adjacent one of said fork sides and having a pivot shaft bore formed therein, said pivot shaft bores being coaxial;
a shaft extending through said space between said intermediate blocks, into said pivot shaft bores, and short of said fork sides, said shaft having a shaft axis;
a pivot arm having one end fixed to said shaft, and being pivotable about said shaft axis; and
a support wheel rotatably fixed to an opposing end of said pivot arm.

2. The assembly as in claim 1, in which at least one of said intermediate blocks has a top in contact with said fork top wall.

3. The assembly as in claim 1, in which at least one of said intermediate blocks is fixed to said fork by a fastener extending through an opening formed in said fork sidewall adjacent said at least one intermediate block, said opening being rearwardly of said shaft axis.

4. The assembly as in claim 3, in which said fastener is a bolt extending through said opening and threadably engaging a nut disposed in said space between said intermediate blocks.

5. The assembly as in claim 1, in which at least one of said intermediate blocks is fixed to said fork by a fastener extending through an opening formed in said fork top wall.

6. The assembly as in claim 5, in which said opening is formed forwardly of said shaft axis.

7. The assembly as in claim 1, in which each of said intermediate blocks are formed from a single piece.

8. The assembly as in claim 1, in which a slot is formed in a side of at least one of said intermediate blocks adjacent one of said fork side walls, said slot intersecting said pivot shaft bore of said at least one intermediate block.

9. The assembly as in claim 8, in which a member fixed to an end of said shaft is captured in said slot to prevent rotation of said shaft in said pivot shaft bore.

10. The assembly as in claim 8, in which said slot is wedge shaped, and an end of said shaft includes at least one flat engaging said wedge shaped slot to prevent rotation of said shaft in said pivot shaft bore.

11. A pallet truck comprising:
a truck body;
a control handle extending from said truck body;
at least one elongated fork extending forwardly from said truck body, and being fixed to said truck body for vertical movement, said fork including a top wall extending between fork ends and a pair of side walls extending from opposing edges of said top wall to form a downwardly opening cavity extending at least partially between said fork ends;
a pair of opposing intermediate blocks rigidly fixed to said fork and defining a space therebetween, each block being adjacent one of said fork sides and having a pivot shaft bore formed therein, said pivot shaft bores being coaxial;
a shaft extending through said space between said intermediate blocks, into said pivot shaft bores, and short of said fork sides, said shaft having a shaft axis;
a pivot arm having one end fixed to said shaft, and being pivotable about said shaft axis; and
a support wheel rotatably fixed to an opposing end of said pivot arm.

12. The pallet truck as in claim 11, in which at least one of said intermediate blocks has a top in contact with said fork top wall.

13. The pallet truck as in claim 11, in which at least one of said intermediate blocks is fixed to said fork by a fastener extending through an opening formed in said fork sidewall adjacent said at least one intermediate block, said opening being rearwardly of said shaft axis.

14. The pallet truck as in claim 13, in which said fastener is a bolt extending through said opening and threadably engaging a nut disposed in said space between said intermediate blocks.

15. The pallet truck as in claim 11, in which at least one of said intermediate blocks is fixed to said fork by a fastener extending through an opening formed in said fork top wall.

16. The pallet truck as in claim 15, in which said opening is formed forwardly of said shaft axis.

17. The pallet truck as in claim 11, in which each of said intermediate blocks are formed from a single piece.

18. The pallet truck as in claim 11, in which a slot is formed in a side of at least one of said intermediate blocks adjacent said one of said fork side walls, said slot intersecting said pivot shaft bore of said at least one intermediate block.

19. The pallet truck as in claim 18, in which a member fixed to an end of said shaft is captured in said slot to prevent rotation of said shaft in said pivot shaft bore.

20. The pallet truck as in claim 18, in which said slot is wedge shaped, and an end of said shaft includes at least one flat engaging said wedge shaped slot to prevent rotation of said shaft in said pivot shaft bore.

21. A fork trail assembly comprising:
a pair of intermediate blocks fixable to a pallet truck fork to define a space between said blocks;
a pivot shaft extending between said blocks through said space, and defining a pivot shaft axis;
a pivot arm having one end pivotally fixed to said pivot shaft for pivotal movement about said pivot shaft axis, said pivot arm having an opposing end;
at least one ground engaging wheel rotatably mounted to said pivot arm opposing end.

22. The assembly as in claim 21, in which a member is pivotally fixed to said pivot arm, wherein said member exerts a force on said pivot arm to pivot said arm about said pivot shaft axis.

23. The assembly as in claim 21, in which at least one of said intermediate blocks includes an opening formed through said intermediate block for receiving a fastener, said opening having an axis which is offset from said shaft axis.

24. The assembly as in claim 23, in which said fastener is a bolt extending through said opening.

25. The assembly as in claim 21, in which each of said intermediate blocks are formed from a single piece.

26. The assembly as in claim 21, in which a slot is formed in a side of at least one of said intermediate blocks, said slot intersecting said pivot shaft.

27. The assembly as in claim 26, in which a member fixed to an end of said shaft is captured in said slot to prevent rotation of said shaft.

28. The assembly as in claim 26, in which said slot is wedge shaped, and an end of said shaft includes at least one flat engaging said wedge shaped slot to prevent rotation of said shaft.
